(19) United States
(12) Patent Application Publication
(10) Pub. No.: US 2011/0293839 A1
(43) Pub. Date: Dec. 1, 2011

(54) WATER-BASED IMPERMEABILIZATION COMPOSITION FOR COATING DIVERSE SUBSTRATES

(75) Inventor: Ricardo Luis Rodriguez Cantú, Nuevo Leon (MX)

(73) Assignee: POLIMEROS, ADHESIVOS Y DERIVADOS, S.A. DE C.V., Nuevo Leon (MX)

(21) Appl. No.: 13/063,626

(22) PCT Filed: Jul. 8, 2009
(86) PCT No.: PCT/MX2009/000063

§ 371 Date: Jun. 24, 2011

(30) Foreign Application Priority Data
Sep. 12, 2008 (MX) MX/A/2008/011693

(51) Int. Cl. C09D 133/00; C09D 7/12; B05D 3/00; B05D 7/24; B05D 7/00; B05D 7/02; B05D 7/06; C09D 5/00; B05D 1/38

(52) U.S. Cl. 427/325; 524/556; 524/353; 524/269; 524/502; 524/515; 427/299; 427/322; 524/323

(57) ABSTRACT

The present invention relates to a water-based waterproof composition for coating different substrates characterized in that it is formulated by including a elastomeric acrylic comprising a mechanical reinforcing fiber of an elastic material produced by a fiber yarn process, that, once applied and dried keeps its elongation properties.

### FIELD OF THE INVENTION

The present invention relates generally to the chemical industry, particularly it relates to the coating production industry and especially to the production of waterproofing compositions for roof and other building elements in civil work.

### BACKGROUND OF THE INVENTION

Products on the market, known so far, are fiberless elastomeric acrylic waterproof products that are applied on a surface and, before the first layer dries, a reinforcing fabric roll is extended over and, after it dries, a second hand is applied. Other waterproof products carry reinforcing materials containing fiber material, said fiber being non-elastic polyester or cellulose, other materials include, among others, rubber from ground tires.

Most of the common reinforcing fibers available on the market are acrylic, polyester, polypropylene, nylon, cellulose, glass fibers, among others, and their use result in being too rigid, i.e. flexible but elastic.

Current waterproof products carry, as an application system, a reinforcing fiber which rises application labor and materials costs, extend application time and require specialized manpower. The ever-changing weather that cause drastic fluctuations in temperature, relative humidity, frequent rain in rainy seasons, etc., renders the reinforcing fiber brittle and impaired in the short term.

Also, in conditions where waterproof products are kept dry, elasticity deteriorates causing reinforcing fabric's breakdown which in turn causes crevices and cracks on the waterproof product surface, and therefore adversely affecting said waterproof product surface.

Because of the above, an elastomeric acrylic waterproof composition which could address the drawbacks set forth, while also being durable, elastic, easily applicable, and which gives the best results and greatest efficiency, would be of great advantage over waterproof compositions currently known in the art.

### OBJECTS OF THE INVENTION

The primary object of the present invention is to make available an elastomeric acrylic waterproof composition that is easily applicable without the need of specialized manpower and not necessitating the use of a reinforcing fiber.

Another object of the present invention is to make available said elastomeric acrylic waterproof composition, which further, at high temperature and low relative humidity conditions, neither reduces its elongation nor affects its physical and chemical properties.

Another object of the invention is to make available said elastomeric acrylic waterproof composition that further does not require the use of a reinforcing fiber to bring both good performance and efficiency.

Another object of the invention is to make available said elastomeric acrylic waterproof composition that also reduces application times.

Yet another objective of the invention is to allow for the elastomeric acrylic waterproof composition to be used in any kind of weather, thanks to its weather resistance without any loss in its properties.

Still another object of the invention is to make available said elastomeric acrylic waterproof composition that additionally does not require the use of any further product to provide excellent waterproofing to different substrates.

Still another object of the invention is to make available said elastomeric acrylic waterproof composition which further allows for the blockage of both water and humidity infiltration.

Additional features and objectives will be apparent from both the general and detailed description of the present invention when supported by the illustrated embodiments.

### DESCRIPTION OF THE INVENTION

Generally, the waterproof composition consists of an elastomeric acrylic waterproof composition comprising a mechanical reinforcing fiber of an elastic material produced by a fiber yarn process that, once applied and dried keeps its elongation properties.

The basic aspect of the elastomeric acrylic waterproof composition is the use of elastic fibers of any gauge and length.

The main role of said elastomeric acrylic waterproof composition is waterproofing of concrete or polyurethane roofs, wood or asbestos sheets.

The composition is designed such that the use of a reinforcing fabric is not necessary and therefore this step is avoided, in this way a single layer is applied over the substrate surface previously primed, then it is left to dry an then a second layer can be applied.

The waterproof composition comprises a binder resin, a film forming coalescer, a rheology modifier, a stabilizer dispersant, a preservative, a pH buffer, moistener, a diluent, a foam controller, a drying controller, fillers and extenders, and an elastic mechanical reinforcement.

Also, the waterproof composition can include a water softener and pigments.

The binder resin comprises preferably a 50% styrenized emulsified acrylic resin, said film forming coalescer comprises preferable a pentane diol solvent, said rheology modifier, comprises a water-based acrylic thickener, said stabilizer dispersant comprises a poly-acrylic salt, said preservative consists of a formaldehyde solution, said pH buffer comprises a 28% ammonium hydroxide solution, said moistener comprises an alkyl phenol, said diluent consists of industrial water, said foam regulator comprises wax and naphtha, said drying controller being a glycolic solvent, the filler and extenders comprise calcium carbonate, and said elastic mechanical reinforcement consists of elastic fiber. Said water softener comprises a phosphated salt and said pigment is selected from white pigment like titanium dioxide or terracotta pigment like red and/or yellow iron oxide.

The table below shows the waterproof composition and the function of each element in the formula thereof.

| COMPOUND | FUNCTION |
|---|---|
| Industrial water | Diluent |
| Alkyl phenol | Moistener |
| Titanium dioxide | White pigment |
| Calcium carbonate | Filler and extender |
| Wax and naphtha emulsifier | Foam regulator |
| Water based acrylic thickener | Rheology modifier |
| Elastic fiber | Mechanical reinforcement |
| Emulsified 50% styrinized acrylic resin | Binder resin |
| Phosphated salt | Water softener |
| Poly-acrylic salt | Stabilizer dispersant |
| 37% Formaldehyde solution | Preservative |
| 28% Ammonium Hydroxide solution | pH buffer |
| Glycolic solvent | Drying controller |
| Pentane diol solvent | Film forming coalescer |

Preferably, said waterproof product has the following quantitative composition, wherein two qualities are noted:

| | | | ‘MEGA’ | ‘ULTRA’ |
|---|---|---|---|---|
| | | | QUALITY | QUALITY |
| WATERPROOF COMPOUNDS | | | Quantity | Quantity |
| | | Quantity | Exact | Exact |
| | | Weight % | amount | amount |
| COMPOUND | | range | Weight % | Weight % |
| 1. | Industrial water | 20.00-28.00 | 26.85 | 22.05 |
| 2. | Alkyl phenol | 0.03-0.30 | 0.05 | 0.05 |
| 3. | Titanium dioxide | 0.00-10.00 | 2.30 | 5.50 |
| 4. | Calcium carbonate | 20-40.00 | 34.00 | 29.30 |
| 5. | Wax and naphtha emulsifier | 0.20-1.00 | 0.40 | 0.40 |
| 6. | Water based acrylic thickener | 0.50-2.00 | 1.00 | 1.00 |
| 7. | Elastic fiber | 0.50-3.00 | 1.00 | 1.00 |
| 8. | Emulsified water-based resin* | 20.00-55.00 | 31.50 | 38.00 |
| 9. | Phosphated salt | 0.01-0.50 | 0.05 | 0.05 |
| 10. | Poly-acrylic salt | 0.01-2.00 | 0.05 | 0.05 |
| 11. | 37% Formaldehyde solution | 0.10-0.80 | 0.20 | 0.20 |
| 12. | 28% Ammonium Hydroxide | 0.10-0.80 | 0.40 | 0.40 |
| | solution | | | |
| 13. | Glycolic solvent | 0.00-5.00 | 1.10 | 1.00 |
| 14. | Penthane diol solvent | 0.00-3.00 | 1.10 | 1.00 |

| | | |
|---|---|---|
| Total Percent | 100 | 100 |

*The emulsified water-based resin can be of a pure acrylic and/or styrene-containing acrylic type, as well as any other elastomeric resin used in waterproof formulations.

Additionally said composition can include red and/yellow iron dioxide to provide the waterproof composition with a red terra cotta color. In a quantity from 0.00 to 5.00 weight % and 3.20 weight % Mega quality waterproof composition and finally 3.20 weight % Ultra quality waterproof composition.

The elastic fiber as a mechanical reinforcement is selected from elastane fibers, gum fibers (rubber band-like), neoprene fiber, natural rubber or synthetic rubber fiber, as well as other natural elastic fibers and synthetic elastic fibers; where elastic fibers are those that can be stretched without any breakage and when released they recover its initial state, but can show some fatigue without recovering its original length.

The waterproof composition comprises the physical and chemical properties as shown in the following table for both the ULTRA and MEGA waterproof composition qualities:

| Physical and | | | |
|---|---|---|---|
| Chemical | | | |
| Properties | ASTM | “IMPAC ULTRA” | “IMPAC MEGA” |
| Density | ASTM D-1475 | 1.32 +/− 0.05 | 1.32 +/− 0.05 |
| Viscosity | ASTM D-2196 | 60,000-65,000 cps | 60,000-65,000 cps |
| pH | ASTM E-70 | 9-10 | 9-10 |
| Solids | ASTM D-1644 | 53% +/− 2 | 52% +/− 2 |
| Elongation | ASTM D-2370 | 200% to 430% | 200% to 550% |
| Stability | ASTM D-1849 | Passes 52° C. | Passes 52° C. |
| | | Stability | Stability |

The elastomeric acrylic used in said waterproof composition consists of a resin-in-emulsion comprising acrylic monomers, having the following physical and chemical properties:

| Pysical and Chemical | | |
|---|---|---|
| Properties | ASTM | Emulsified Resin** |
| Density | ASTM D-1475 | 1.00 +/− 0.05 |
| Viscosity | ASTM D-2196 | 1,000-25,000 CPS |
| pH | ASTM E-70 | 3-10 |
| Solids | ASTM D-1644 | 53% +/− 2 |
| Elongation | ASTM D-2370 | Higher than 600% |
| Stability | ASTM D-1849 | Passes 52° C. Stability |

**The water-based emulsified resin can be pure acrylic and/or styrene-acrylic, as well as any other elastomeric resin type used for waterproofing formulations.

The invention has been described in sufficient detail to enable one skilled in the art to reproduce and obtain the results as already disclosed in the present invention. Nevertheless, any person skilled in the field of the art in relation to the present invention can be able to make modification not described in the present application, however, if the subject matter as claimed in the following claims is required in order to apply such modifications on a given structure or in the manufacture process thereof, said structures should fall within the scope of the invention.

1. A water-based waterproof composition for coating different substrates, said composition comprising an aqueous dispersion containing an acrylic elastomeric copolymer comprising mechanical reinforcement fibers of an elastic material produced by a fiber yarn process, which once applied and dried keeps its elongation properties.

2. The water-based waterproof composition of claim 1, further comprising a binder resin, a film forming coalescer, a theology modifier, a stabilizer dispersant, a preservative, a pH buffer, a moistener, a diluent, a foam controller, a drying controller, and fillers and extenders.

3. The water-based waterproof composition of claim 2, further comprising a water softener and pigments.

4. The water-based waterproof composition of claim 3, wherein said binder resin comprises a styrenized emulsified acrylic resin, said film forming coalescer comprises a pentane diol solvent, said rheology modifier comprises a water-based acrylic thickener, said stabilizer dispersant comprises a poly-acrylic salt, said preservative of a formaldehyde solution, said pH buffer comprises an ammonium hydroxide solution, said moistener comprises an alkyl phenol, said diluent comprises industrial water, said foam controller comprises wax and naphtha, said drying controller being a glycolic solvent, said fillers and extenders comprise calcium carbonate, and said elastic mechanical reinforcement comprising elastic fibers; said water softener comprises a phosphated salt and said pigment is selected from the group consisting of white pigment like titanium dioxide or terracotta pigment like red and/or yellow iron oxide.

5. The water-based waterproof composition of claim 4, wherein the composition comprises from 20 to 55% of a 50% styrenized emulsified acrylic resin, no more than 3% pentane diol solvent, from 0.5 to 2% water-based acrylic thickener, from 0.1 to 2% poly-acrylic salt, from 0.1 to 0.8% of 37% formaldehyde solution, from 0.1 to 0.8% of 28% ammonium hydroxide solution, from 0.03 to 0.3% alkyl phenol, from 20 to 28% industrial water, from 0.2 to 1% wax and naphtha, no more than 5% glycolic solvent, from 20 to 40% calcium carbonate, from 0.5 to 3% elastic fibers; 0.01 to 0.5% phosphated salt, and from 0 to 10% titanium dioxide and from 0 to 5% iron oxide.

6. The water-based waterproof composition of claim 4, wherein said elastic fiber used as a mechanical reinforcement is selected from the group consisting of elastane fibers, gum fibers, neoprene fiber, natural rubber, synthetic rubber fiber, natural elastic fibers, and synthetic elastic fibers, which can be stretched without breakage despite showing fatigue and not recovering its original length.

7. The water-based waterproof composition of claim 6, wherein said elastane fibers comprise linear non-woven fibers having multi- or monofilaments of a polyurethane-urea polymer.

8. The water-based waterproof composition of claim 7, wherein said elastane fibers further comprise stabilizers, pigments and lubricants.

9. The water-based waterproof composition of claim 8, wherein said pigments comprise titanium oxide and/or zinc oxide.

10. The water-based waterproof composition of claim 8, wherein said lubricants comprise silicon oil and/or magnesium stearate.

11. The water-based waterproof composition of claim 1, wherein said elastomeric acrylic is an emulsified resin comprising acrylic monomers of pure acrylic and/or styrenized acrylic, or any kind of elastomeric resin.

12. The water-based waterproof composition of claim 1, wherein said application substrate is selected from the group consisting of concrete or polyurethane substrates, and wood or asbestos sheets.

13. A water-based waterproof composition for coating different substrates, said composition comprising an aqueous dispersion comprising:
elastomeric acrylic mechanical reinforcement fibers produced by a fiber yarn process, which once applied and dried keeps its elongation properties; and
a binder resin.

14. The water-based composition of claim 13, further comprising:
a film forming coalesce;
a theology modifier;
a stabilizer dispersant;
a preservative;
a pH buffer;
a moistener;
a diluent;
a foam controller;
a drying controller; and
optionally fillers and extenders.

15. The water-based composition of claim 13, wherein said binder resin comprises a styrenized emulsified acrylic resin.

16. The water-based composition of claim 14, wherein said film forming coalescer comprises a pentane diol solvent, said rheology modifier comprises a water-based acrylic thickener, said stabilizer dispersant comprises a poly-acrylic salt, said preservative of a formaldehyde solution, said pH buffer comprises an ammonium hydroxide solution, said moistener comprises an alkyl phenol, said diluent comprises industrial water, said foam controller comprises wax and naphtha, said drying controller being a glycolic solvent, said fillers and extenders comprise calcium carbonate, and said elastic mechanical reinforcement comprising elastic fibers; said water softener comprises a phosphated salt and said pigment is selected from the group consisting of white pigment like titanium dioxide or terracotta pigment like red and/or yellow iron oxide.

17. The water-based composition of claim 16, further comprising a water softener and pigments, wherein the composition comprises from 20 to 55% of a 50% styrenized emulsified acrylic resin, no more than 3% pentane diol solvent, from 0.5 to 2% water-based acrylic thickener, from 0.1 to 2% poly-acrylic salt, from 0.1 to 0.8% of 37% formaldehyde solution, from 0.1 to 0.8% of 28% ammonium hydroxide solution, from 0.03 to 0.3% alkyl phenol, from 20 to 28% industrial water, from 0.2 to 1% wax and naphtha, no more than 5% glycolic solvent, from 20 to 40% calcium carbonate, from 0.5 to 3% elastic fibers; 0.01 to 0.5% phosphated salt, and from 0 to 10% titanium dioxide and from 0 to 5% iron oxide.

18. The water-based composition of claim 17, wherein the elastomeric acrylic is a copolymer and wherein said elastic fibers comprise elastane fibers comprising linear non-woven fibers having multi- or monofilaments of a polyurethane-urea polymer.

19. The water-based waterproof composition of claim 15, wherein the components of the composition comprise the following in the following wt. %:

| Component | Quantity weight % range |
|---|---|
| Industrial water | 20.00-28.00 |
| Alkyl phenol | 0.03-0.30 |
| Titanium dioxide | 0.00-10.00 |
| Calcium carbonate | 20-40.00 |
| Wax and naphtha emulsifier | 0.20-1.00 |
| Water-based acrylic thickener | 0.50-2.00 |
| Elastic fiber | 0.50-3.00 |
| Emulsified water-based resin | 20.00-55.00 |
| Phosphated salt | 0.01-0.50 |
| Poly-acrylic salt | 0.01-2.00 |
| 37% Formaldehyde solution | 0.10-0.80 |
| 28% Ammonium Hydroxide solution | 0.10-0.80 |
| Glycolic solvent | 0.00-5.00 |
| Penthane diol solvent | 0.00-3.00 |

20. A method of coating a substrate, said method comprising:
providing a substrate selected from the group consisting of concrete or polyurethane substrates and wood or asbestos sheets;
priming a surface of the substrate;
applying the waterproof composition of claim 1 over the primed substrate surface;
letting the composition dry; and
optionally applying, and later drying, a second layer of the waterproof composition over the dried composition.
